(19) United States
(12) Patent Application Publication
(10) Pub. No.: US 2015/0126132 A1
(43) Pub. Date: May 7, 2015

(54) METHODS AND APPARATUS FOR RADIO CO-EXISTENCE TESTING AND VERIFICATION OF WIRELESS SYSTEMS

(71) Applicant: Apple Inc., Cupertino, CA (US)

(72) Inventors: Gary Chung, Menlo Park, CA (US); Qishan Yu, Cupertino, CA (US)

(73) Assignee: Apple Inc., Cupertino, CA (US)

(21) Appl. No.: 14/070,295

(22) Filed: Nov. 1, 2013

(51) Int. Cl. H04B 17/00; G06F 3/0484; H04B 1/38

(52) U.S. Cl. CPC H04B 17/00; H04B 1/3827; G06F 3/04842
USPC 455/67.14

(57) ABSTRACT

Apparatus and methods for radio co-existence and/or component testing in wireless-enabled electronic devices. In one embodiment, a wireless-enabled electronic device (ED) is coupled to a user interface. Test personnel or other supervisory entities can execute test scripts from the user interface. Unlike prior art testing configurations, the disclosed embodiments are configured to perform testing without requiring additional equipment, configuration changes, etc. to the device being evaluated. In one exemplary case, the test scripts are configured to test various co-existence scenarios. The resulting data can be used to quickly identify problem devices via highly accurate results, as well as provide useful statistical data.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technical Field

The present disclosure relates generally to the field of manufacturing and test systems, and more particularly in one exemplary embodiment to rapid, cost effective testing of wireless devices.

2. Description of Related Technology

Manufacturers typically perform a large number of tests during and after manufacture of an electronic device, so as to inter alia, ensure that devices are constructed properly and operate within acceptable tolerances. Unfortunately, longer and more complicated test procedures can significantly impact manufacturing throughput; longer test times directly impact the number of units that can be produced in a given time period, and hence reduce manufacturing efficiency.

Additionally, debugging issues that arise during development or in production units in the field can be similarly time consuming and costly. For debugging or troubleshooting of devices that are already in service, a customer would for example have to deliver the device to a location where proper external testing equipment is available. This method leaves customers without the use of their device, which leads to added expenses and a loss of valuable time, as well as reduced customer satisfaction.

The Assignee hereof implemented factory tests for various wireless-enabled consumer electronic devices circa 2000. Initially, these factory tests were largely focused on wireless local area network (WLAN) performance according to e.g., the Institute of Electrical and Electronic Engineers (IEEE) 802.11a/b/g/n standards. Early test procedures had a relatively limited number of test cases/configurations, and the overall volume was small, so test time was not a significant factor in manufacturing overhead. However, as consumer electronics have evolved over time (including increased use of multiple air interfaces within a single device), the array of test cases and configurations has grown. Current test procedures test a wide variety of conditions and capabilities, in addition to IEEE 802.11a/b/g/n performance; for example, existing test cases include, inter alia, measurements of platform noise at various conditions (system idle, peak traffic conditions, Universal Serial Bus™ (USB 3.0), Thunderbolt™, Lightning™, Firewire™, High Definition Multimedia Interface™ (HDMI) at 720p and 1080p, active state power management (ASPM), etc.) Bluetooth™ (BT) performance, WLAN/BT isolation, WLAN with 3×3 Multiple Input Multiple Output (MIMO), IEEE 802.11ac WLAN functionality, BT with BTLE (low energy) features, etc. Tests of the foregoing in different physical configurations (e.g., clamshell form factor closed, open, etc.) may also be performed.

Additionally, production volume has significantly increased year-over-year, and hence more devices must be tested in a given time period. As more devices are produced, more instances for debugging are likely to occur in the future, as well.

Exemplary incipient manufacturing requirements (e.g., those of the Assignee hereof) require that test suites provide broad test coverage, yet complete under stringent time constraints e.g., less than 120 seconds (2 minutes) for each device. Moreover, future manufacturing needs will require even more functional coverage, and larger production runs.

In view of these progressively more challenging trends, new schemes are needed for factory testing, as well as for debugging and troubleshooting. Specifically, improved methods and apparatus are needed for rapid, cost effective testing of wireless devices.

### SUMMARY

The present disclosure satisfies the aforementioned needs by providing, inter alia, improved apparatus and methods for radio co-existence testing in wireless-enabled electronic devices.

A method for testing a wireless device having a plurality of wireless transceivers is disclosed. In one embodiment, the method includes: providing a user interface including at least a display and an input device (e.g., keyboard input); responsive to a user selecting a routine (e.g., test script) associated with at least one radio interface, executing the selected test script; collecting data associated with the executed test script via the at least one radio interface; post-processing the collected data; and reporting one or more results via the user interface.

In one variant, the display and the input device are located on the wireless device. In other variants, at least one of the display and the input device is a distinct peripheral which is externally connected to the wireless device.

In a second variant, the test script is configured to measure a received signal strength. In some cases, the measured received signal strength is set as a baseline performance. For example, the test script may be configured to measure a second received signal strength while at least one other radio interface is enabled, and the post-processing includes determining the difference between the second received signal strength and the baseline performance.

In some implementations, post-processing the collected data includes calculating a Fast Fourier Transform (FFT) of the collected data. In one such variant, the reporting of the one or more results include displaying a graphical plot of the FFT.

A wireless device configured to perform one or more tests is disclosed. In one embodiment, the wireless device includes: a plurality of wireless transceivers configured to transmit and receive wireless signals according to one or more radio technologies; logic configured to provide a user interface; logic configured to execute a routine (e.g., test script) associated with at least one radio interface selected by a user; logic configured to collect data associated with the executed test script via the at least one radio interface; logic configured to post-process the collected data; and logic configured to report one or more results via the user interface.

In another embodiment, the wireless device includes: a plurality of wireless transceivers configured to transmit and receive wireless signals according to one or more radio technologies; a processor; and a non-transitory computer readable medium. In one exemplary embodiment, the non-transitory computer readable medium includes one or more programs with instructions that are configured to, when executed by the processor, cause the wireless device to: responsive to starting an automated test mode, execute one or more test scripts, the one or more test scripts associated with at least a first transceiver of the plurality of wireless transceivers; collect test data associated with the via the first transceiver; and transmit the test data to an external database.

In one variant, the test data includes one or more In-phase and Quadrature (IQ) data samples received via the first transceiver.

In some cases, the non-transitory computer readable medium may include one or more instructions configured to enable the first transceiver, and disable all other transceivers. In other cases, the non-transitory computer readable medium may include one or more instructions configured to enable the first transceiver, and enable at least one other transceiver.

In some variants, the one or more instructions configured to post-process the collected test data are performed with the processor of the wireless device. In some cases, the external data base is configured to generate statistical data from test data collected from a plurality of wireless devices.

A method for testing a plurality of wireless devices is also disclosed. In one embodiment, the method includes, for each wireless device of the plurality of wireless devices: initiating a test procedure, the test procedure causing the each wireless device to execute one or more test scripts, each test script associated with a transceiver selected from a plurality of transceivers of the wireless device; collecting test data corresponding to each wireless device; and post-processing the collected data the post-processing including statistical analysis.

In one such case, the executed one or more test scripts are configured to test at least one co-existence scenario.

In other cases, the executed one or more test scripts are configured to test at least one baseline scenario.

Certain disclosed variants may perform the statistical analysis to determine an operational tolerance, and/or to identify adverse component interactions.

Other features and advantages described herein will immediately be recognized by persons of ordinary skill in the art with reference to the attached drawings and detailed description of exemplary embodiments as given below.

### BRIEF DESCRIPTION OF THE DRAWINGS

FIG. 1 is a logical flow diagram illustrating one embodiment of a generalized method for co-existence testing of a wireless-enabled electronic device.

FIG. 2 is a logical block diagram of a wireless-enabled electronic device (ED) apparatus useful in conjunction with the method of FIG. 1.

FIG. 3 is a logical block diagram of one exemplary implementation a wireless-enabled electronic device (ED) having a plurality of air interfaces.

FIG. 4 is a logical flow diagram illustrating one exemplary test process for co-existence testing of the ED of FIG. 3.

All Figures © Copyright 2012-2013 Apple Inc. All rights reserved.

### DETAILED DESCRIPTION

Reference is now made to the drawings wherein like numbers refer to like parts throughout.

### Overview

The present disclosure provides, inter cilia, methods and apparatus for radio co-existence testing in wireless devices. In one exemplary embodiment, a wireless-enabled electronic device (referred to throughout as the electronic device (ED)) is tested by initiating routines (such as for example test scripts) on an application or other processor (AP) internal to the ED. During the testing procedure, the ED measures signal dissonance or interference from other wireless radios within the ED by determining a baseline measurement, and variably powering on and off radios within the ED, changing various power settings, modulation and coding schemes, etc. Traditional testing schemes require an external testing device for providing an external signal to be injected into the antenna of the radios being tested, which frequently requires the device to be reworked (i.e., the physical configuration is changed to connect to the external testing device). Advantageously, by using internally generated signals from assembled EDs and running test scripts located on the ED itself, the aforementioned internal testing protocol significantly improves test accuracy and test operation time.

For reasons described in greater detail hereinafter, the exemplary ED is configured to perform in a test mode in addition to performing the primary functionality of the ED. More directly, in one exemplary variant, the ED configures itself to use its application processor (AP) to perform one or more co-existence tests and process the results internally, rather than using separate/external test equipment. In some variants, the ED may additionally store the results within an internal memory component. An external computing or other device (such as a database server) can extract the stored results from the ED in order to compile data for more computationally complex processing, statistical comparison over multiple EDs, etc. Likewise, another variant of the ED can obtain data regarding other EDs from an external entity, and perform at least some of the aforementioned processing internally if desired.

In yet another aspect, apparatus and methods are disclosed which identify undesired or problematic interactions with one or more wireless transceivers and one or more components of the same ED. For instance, in one embodiment, a given wireless transceiver is operated in conjunction with another component (or combinations of components), such as e.g., display devices, cameras, power supplies, etc. (each of which may produce undesirable electromagnetic emissions), so as to identify the problematic interactions.

Various other features of the present disclosure will be readily recognized by those of ordinary skill in the related arts, given the contents of the present disclosure.

### Detailed Description of Exemplary Embodiments

Exemplary embodiments are now described in detail. While these embodiments are primarily discussed in the context of automatic test and verification of radio co-existence during device manufacture, it is appreciated that various principles described herein have broader applicability. For example, similar systems may be used for post-manufacture testing for e.g., field diagnostics (e.g., using third party service technicians, etc.), premises diagnostics (e.g., as initiated by the device user, in situ), etc.

Moreover, while described herein primarily in the context of commercial or “for profit” manufacturing testing, it will appreciated the various features of the disclosure may be applied to other contexts, including for instance government or military applications.

Additionally, as used herein, the term “test” denotes, without limitation, a procedure or steps intended to elicit a result. While test results can be a “pass” or a “fail” or binary, it is appreciated that certain tests may not be pass/fail in nature, and may provide values, vectors, gradients, or even “fuzzy logic” type feedback (e.g., “good”, “poor”, “high” “low”, etc.). For example, calibration tests may return a range of results which are used for adjusting device performance on an individual basis. Calibration tests are commonly used to configure e.g., analog components which may include, for example, radio measurements, touch screen measurements, power (voltage and/or current) measurements, physical switch/button sensitivity, volume adjustment, brightness adjustment, color balance, light sensors (e.g., charge coupled diode (CCD), photo diodes), etc.

While the following description is provided largely within the context of cellular, GPS, and/or Wi-Fi co-existence testing, it is appreciated by those of ordinary skill that the various principles described herein are applicable to virtually any wireless communication, including e.g., 3G/LTE, Global Positioning System (GPS), Wireless Microwave Access (WiMAX), Ultra-wideband (UWB), and Personal Area Networks (PAN) such as Bluetooth which can benefit from reduced test equipment costs (e.g., by avoiding specialized test equipment).

### Wireless Device Testing Procedures—

In order to ensure proper performance, consumer devices are tested for their conformance to expected operational behavior and tolerances. Those of ordinary skill in the related arts will recognize that wireless functional testing presents multiple unique challenges; specifically, radio frequency (RF) behavior is notoriously unpredictable and non-linear. Even small changes to component layout or other parameters can drastically change RF performance and/or electromagnetic interference (EMI).

Moreover, existing test equipment is typically configured to be connected to the device under test (DUT) in unrealistic configurations. For example, in one such configuration, a DUT may have its antenna re-worked (i.e., the existing antenna component is removed, and replaced) with a sub-miniature version A (SMA) connector. The connector is connected via a short SMA cable to testing equipment. The test equipment provides test stimulus, and measures test output via the SMA cable assembly.

The re-work and cable connection required for existing test setups is very intrusive. Given the sensitive and unpredictable nature of RF testing, it is not unusual for test performance to differ significantly from actual performance. Consequently, existing device designers have focused on making devices with large tolerances to accommodate marginal design. Unfortunately, large tolerances can correspond to several disabilities such as lower performance, and more expensive components.

Additionally, in relatively recent history, device manufacturers have started to encounter co-existence type problems. Co-existence type problems occur when two or more nearby but unrelated radio access technologies (RATs) interfere with one another. Prior art testing is generally performed under single RAT optimal conditions (i.e., all other interfering components are disabled), thus existing test methods are not well suited to testing for co-existence type problems.

Within this context, various embodiments of the present disclosure are directed to the testing and verification of radio co-existence within the device, with little if any modification to the existing device construction. More generally, the present disclosure is directed to maximizing the device's own internal capabilities and components to perform radio co-existence testing without the use of expensive test equipment and/or contrived or unrealistic test conditions.

### Methods—

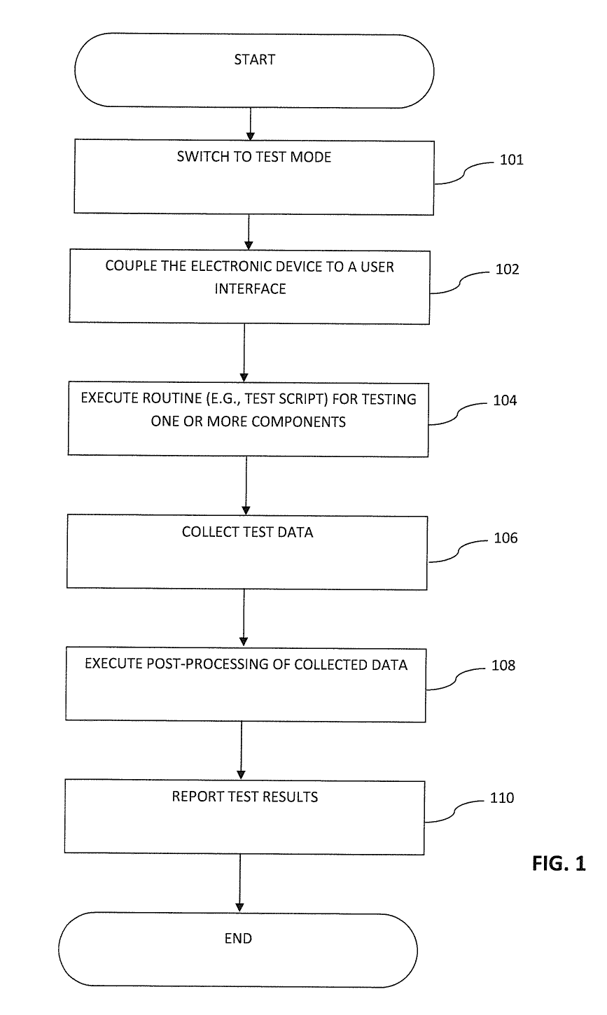

FIG. 1 illustrates one embodiment of a generalized method 100 for co-existence testing of a wireless-enabled electronic device (ED) having a plurality of wireless transceivers according to the disclosure. In one implementation, the ED configures itself as a testing device, using the application processor (AP) of the ED to execute test scripts. Unlike existing test configurations that require the ED to connect to a separate test server, the exemplary ED provides a user interface (UI) (e.g., graphical display, and a keyboard or other input device) which can be used to initiate and control one or a battery of tests. More directly, a user can control test flow directly from the ED itself (i.e., the ED performs the functions of test equipment/test server, etc.). It will be appreciated, however, that one significant feature of the present disclosure is the utilization of internal ED components and scripts to perform testing, and hence the control of the testing may, in certain cases, be controlled via an external agent or device, yet performed internal to the ED under test.

By locally performing test scripts on the ED, the exemplary embodiment of the ED can quickly determine whether co-existence values are within range, without connecting the ED to a separate test apparatus. For example, co-existence performance can be measured between active co-existing radio receivers, as described herein in various disclosed embodiments. More directly, internal testing allows the ED to independently perform co-existence testing during development.

Additionally, it is appreciated that the relatively minimal requirements for testing (e.g., lack of specialized test equipment, test vectors, etc.) ensure that the described procedures can be performed e.g., for final assembly and test (i.e., after the ED is manufactured, and before it is shipped to customers), as well as for debugging EDs in the field. The elimination of a separate testing device significantly reduces testing complexity, as well as testing setup and operation time.

As a brief aside, specialized test equipment functionally offers multiple layers of visibility into radio operation. With trained personnel, virtually any problem in the physical hardware or software can be detected. However, for the purposes of co-existence testing, the extraordinary amount of capabilities provided by test equipment is largely unnecessary. In fact, for co-existence testing, it is generally assumed that the individual radios, taken in isolation, will perform satisfactorily. Rather, co-existence type problems are commonly introduced at physical radio interference; accordingly, co-existence problems can often be identified by powering on transmitters and monitoring for problematic interference artifacts.

Moreover, it should be appreciated that the non-intrusive nature of the ED test configuration of the exemplary embodiments described herein will further improve the accuracy of test results. Unlike existing test configurations which typically require intrusive rework of the ED to couple to test equipment, the various described embodiments are configured to enable test operation with the ED “as is”. Since the ED performs tests with an unchanged physical configuration, the test results advantageously reflect actual RF performance under “normal” operating conditions (i.e., those that would be encountered during a user's typical operation of the device). Accurate test results also directly result in better calibration, improved performance, and lower component costs.

Referring now to FIG. 1, at step 101 of the method 100, the electronic device (ED) enters or invokes a test mode of operation.

As used hereinafter, the term “electronic device” refers generally and without limitation to any electronic device which has been configured to operate according to a first normal operation mode, and at least one or more test modes. In one exemplary embodiment, the electronic device includes one or more wireless interfaces. Common examples of wireless interfaces include without limitation, cellular interfaces, satellite interfaces, wireless local area network (WLAN) interfaces, metropolitan area network (MAN) interfaces, personal area network (PAN) interfaces, etc. Various examples of EDs include without limitation: cellular phones (e.g., the iPhone™ manufactured by the Assignee hereof), personal media devices (e.g., the iPod™ manufactured by the Assignee hereof), tablet computing devices (e.g., the iPad™ manufactured by the Assignee hereof), laptop and desktop computers (e.g., the Mac™, and MacBook™ manufactured by the Assignee hereof), etc.

In some implementations, the ED initializes into test operation via a boot process. In other cases, the test mode may be entered via a software setting or application, etc. In still other embodiments, the ED may recognize the insertion or presence of test equipment. For example, an ED may detect a Bluetooth enabled tester, or an inserted USB device may identify itself as a tester, etc. In still other cases, the test mode may be automatically triggered upon an unexpected wireless network failure during normal operation, and/or out-of-tolerance behavior during compliance testing, etc.

Versions of the test software may be further adapted for use within varying contexts. In one instance, an ED may be programmed with a version of test software during manufacture and test, and reprogrammed with customer software for delivery. In another case, the ED may be programmed with a version of test software post deployment (e.g., via an online store such as the AppStore™, which is owned and operated by the Assignee hereof). Still further, different users may have different levels of access; for example, factory personnel may have a different set of permissions and/or capabilities than e.g., technical assistance personnel and/or customer capabilities. Different levels of access can be controlled for example with logins, passwords, etc.

At step 102 of the method 100, the ED is coupled (when necessary) to any external user interface (UI) peripherals. Generally, the UI provides a user (e.g., testing personnel) the ability to provide input instruction and/or specify test vectors to the ED, and observe the test output either directly or indirectly. In one exemplary embodiment, the UI includes one or more of an external peripheral display screen, keyboard, mouse, virtual keyboard, touch input, microphone, etc. Those of ordinary skill in the related arts will readily appreciate that external UI peripheral components (e.g., keyboard, mouse, etc.) can communicate via generic interfaces (e.g., a 30-pin connector, USB, Lightning, Firewire, Thunderbolt, etc.), or a wireless network technology (e.g., Bluetooth, Wi-Fi, etc.). For configurations which may produce significant amounts of test result data, the test results may be made available over the generic interface for post-processing. Certain specialized use cases may additionally incorporate a specialized test fixture for e.g., anechoic chamber testing, standards compliance testing, etc.

Consider an exemplary ED that uses a keyboard (external or virtual) and the indigenous display screen for test feedback. In one case, the user plugs the keyboard into a Lightning™ connector (manufactured by the Assignee hereof) on the ED. During test operation, the user can use the keyboard to provide instruction to the Application Processor (AP), and read test results and/or test status are reported via the display screen. In another such example, user input is provided via one or more buttons on the ED. The one or more buttons may be physical or virtual/emulated. For example, in order to initiate testing, an operator may simply tap a button. The same (or another) button can be used to display test results, skip to the next test, halt testing, etc.

Results may be generated and presented to the operator in several different ways, as described below in greater detail. In a touch-input variant, the UI is virtualized and displayed on the ED's display screen. The user's interaction with the virtualized UI components (e.g., slider bars, dials, buttons, switches, etc.) can result in the configuration and execution of one or more associated test scripts. Each test script may include for example, a selection of one or more specific basebands to test, configuration of test parameters, output format (e.g., output file format, verbose or truncated output, etc.), or any number of other options. Various combinations of the foregoing UI components may be readily implemented by one of ordinary skill in the related arts, given the contents of the present disclosure. Similarly, it is appreciated that for different operational scenarios and/or modes, different UI components may be utilized; for instance, an ED may have a first test mode that utilizes a few physical buttons to start/stop compliance testing, and a second test mode that utilizes a keyboard and more complex graphical interface to assist in trouble shooting non-compliant operation.

At step 104 of the method 100, the ED executes a testing script for testing one or more components of the ED. In one exemplary case, the testing script is selected by the user via the UI. In other cases, the testing script is automatically selected by the ED according to a default test battery. In still other variants, the testing script is automatically selected based on an ED conditional trigger; for example, if the ED experiences especially poor wireless connectivity, the ED may automatically initiate an RF calibration or diagnostic type test.

As used herein, the term “test script” refers generally and without limitation to any instruction or series of instructions which are configured to cause the ED to initialize, execute, and/or evaluate a test procedure. It is appreciated that test scripts are typically used because device testing may require the flexibility to change multiple parameters and/or vary the combination of parameters from test to test. In many cases, test scripts are selectively aggregated together for a default test program with representative test configurations. While script-based testing configuration is described herein, it is appreciated that non-script-based testing may be substituted with equal success by those of ordinary skill in the related arts, given the present disclosure.

As used herein, the term “component” refers generally and without limitation to any electrical component or series of electrical components of the ED which can be tested to comply with one or more measurable performances. Common examples of components include e.g., radio frequency (RF) components, baseband components, processing components, analog components, graphics components, and audio components.

In one exemplary embodiment, the components are, in whole or part, one or more wireless interfaces or “radios”. A wireless transceiver typically consists of one or more of: a RF front end, an analog baseband, and a corresponding digital baseband. The RF front end commonly includes one or more antennas, and corresponding mixers, multiplexers, etc. The RF front end is commonly configured to convert a received RF signal to electrical analog signal constituents and vice versa; the electrical analog signal constituents may additionally be at so called “baseband” frequencies (i.e., where the wireless transmission carrier frequency has been removed). The analog baseband is commonly configured to convert the electrical analog signal constituents to digital signals (and vice versa). In some cases the analog baseband may additionally insert/remove various signaling. Analog basebands commonly include multiple levels of filters, mixers, digital/analog (D/A) converters, analog/digital (A/D) converters, etc. The digital baseband is configured to convert the digital signals to data (and vice versa). In some cases, the digital baseband is a processing element, application specific integrated circuit (ASIC), or other form of programmable logic. Various embodiments may further logically combine or differentiate the RF front end, analog baseband, and/or digital baseband.

Each wireless interface is configured to wirelessly transact information via one or more logical “channels”. Many modern EDs contain multiple basebands, often on closely related or overlapping frequencies. Overlapping and adjacent channel leakage can result in serious performance degradation, thus accurate diagnosis and testing of co-existing radio performance is necessary to optimize co-existing radio performance.

Consider an exemplary test scenario, wherein the user selects one or more test scripts which cause the AP of the ED to perform radio co-existence testing. The selected test scripts may be a “canned” (i.e., pre-set) combination that is automatically run without further user input. Alternatively, the selected test scripts may be manually executed by the user so as to focus on a particular behavior or area of interest (e.g., a detected malfunction, suspected problem, etc.).

With reference to manual test scripts, such scripts rely on one or more parameters and/or test vectors that are input by the user to configure at least one baseband to be tested. Common examples of parameters and/or test vectors include, without limitation: baseband selection, frequency selection, payload selection, transmit power, receive sensitivity, feedback sensitivity, modulation and coding scheme (MCS), and baseband specific parameters (e.g., automatic frequency hopping, antenna selection, etc.). Manually configuring test scripts can be useful for troubleshooting a known or suspected problem with an ED. In one example, the user may be manufacturing personnel troubleshooting a problematic ED, customer service personnel who are investigating a customer complaint, or even an especially savvy user. Other scenarios using manual testing, while not specifically described, are contemplated, and considered within the scope of the present disclosure.

In contrast to manual scripts, automated scripts may include for instance a “canned” series of tests that run without significant user input, and provide limited test result reporting. Common examples of limited test result reporting include e.g., “pass/fail”, and error codes. In some instances, Automated scripts may incorporate testing for multiple components simultaneously, and/or etc. Automated test scripts are particularly useful in, e.g., a factory setting for quality assurance purposes, where each ED coming off of an assembly line can be quickly tested to assure that all of the basebands are performing within acceptable tolerances. Similarly, automated test scripts can be provided to casual users as a simple “triage” test; if a problem is detected via the triage, the casual user will need to take their ED to appropriately skilled maintenance personnel to further diagnose and correct the problem.

One common example of a co-existence test is a so-called “baseline” test. A “baseline” test seeks to determine a point of reference (baseline) that can be used to measure future performance. Subsequent performance that deviates beyond acceptable tolerances from the baseline in one fashion or another may indicate a problem which requires amelioration.

Quality control is another common use of baseline tests; during manufacture, devices that deviate from expected baseline targets are identified and brought into tolerance before shipping to customers.

Within the context of co-existence testing, a baseline result is determined for how each wireless interface within an ED impacts the other co-existing wireless interfaces within the ED. Artisans of ordinary skill will readily appreciate that the co-existence interference can be a result of inter alia, blocking, harmonics, inter-modulation, in-channel noise, as well as noises and spurs due to nonlinear response of the integrated platform or radio transmitters.

Referring back to step 106 of the method 100 of FIG. 1, the ED collects the resulting data. The collected data may vary based on the type of test. For example, while Wi-Fi baseline measurements use RSSI, other co-existence tests may use e.g., signal-to-noise ratio (SNR), bit error rate (BER), block error rate (BLER), adjacent channel leakage ratio (ACLR), I/Q values, receive power, transmit power, etc.

In some embodiments, it is desirable for the ED to perform a baseline for each baseband, with more than one other baseband being powered on (or in a particular operating condition). Any permutation of the number of basebands within an ED can be simultaneously co-existence tested. For example, if an ED has GPS, Wi-Fi, Bluetooth, and GSM radios, a baseline may be measured with just the GPS powered on, with the GPS and Wi-Fi powered on, with the GPS, Wi-Fi, and Bluetooth powered on, with the Wi-Fi and Bluetooth only, etc. Having the ability to determine different baseline metrics corresponding to different combinations of radios is advantageous, as the baselines may be tailored to a realistic operating environment, rather than hypothetical scenarios which may never occur. Additionally, expensive test equipment and testing environments are not necessary to generate the different types of test cases, test signals and/or test/vectors.

For example, to determine the impact of a cellular radio on Wi-Fi within the ED, all basebands can be powered off, and only the Wi-Fi received signal strength indicator (RSSI) is measured. The measured Wi-Fi RSSI (with no other radios being powered on) is considered to be a baseline performance for Wi-Fi operation. A subsequent test may power another radio (e.g., the GPS, cellular radio, etc.) to determine the corresponding impact on Wi-Fi performance. Baseline metrics can be determined for each possible permutation of component and configuration, or a limited subset thereof (e.g., unrealistic or restricted scenarios may not be tested if desired).

At step 108 of the method 100, when desired or necessary, the ED executes post-processing of the collected data. In some cases, the ED performs post-processing of the collected data after each test and/or a group of tests. Alternatively, the post-processing of the collected data may be triggered by one or more other inputs. For example, in some cases, post-processing is performed according to user input (e.g., the user may identify one or more calculations to be performed). User input may take the form of graphical user interface (GUI) type interactions, test script selection, parameter selection, etc. In other cases, post-processing may be automatically triggered by e.g., other test results, other test programs, completion of the data collection script, etc.

It should be further noted that many EDs commonly use internal dedicated hardware circuitry that is configured to calculate e.g., RSSI, SNR, BER, BLER, ACLR, etc. In some cases, post-processing may explicitly re-calculate a value with a CPU (or similar circuitry) to compare the result with the results of the internal dedicated hardware circuitry, so as to e.g., verify proper operation of the internal dedicated hardware.

At step 110 of the method 100, one or more results from the post-processing are reported. In some cases, the reporting may take the form of a “pass”/“fail”, or Boolean (“true”/“false”) type response. However, certain tests may not be binary in nature, and/or may return other types of results (e.g., a value, an array of results, a graphical plot, etc.) that must be interpreted according to complex and/or subjective measures. For example, in certain cases, it may be impractical to account for the myriad of different types of failures in software which can be easily diagnosed by a human.

In one exemplary scenario, the ED compares the determined measurements against acceptable values and/or tolerances. If each measurement is within the acceptable tolerances, the ED is considered to have passed. As previously alluded to, acceptable values and tolerances may be determined based on e.g., historical performance of the ED being evaluated (or others), statistical sampling of other devices, expected performance based on theoretical simulations, anecdotal data (such as from one or more users), etc.

Those of ordinary skill in the related arts will readily appreciate that “reporting” may take any of a variety of audio/visual/electronic form. For example, the reporting may include an email, text message, or other electronic message protocol. Electronic reporting may be directed to test personnel, and/or logged for later analysis, records, etc. In other examples, results may be reported with an audible and/or visual indication. For instance, a display may provide the test output, and issue an audible beep or pattern.

In still other variants, after performing testing, data may be offloaded from the ED onto a separate device, and a spread-sheet, presentation, or other type of graphic may be displayed to provide the results. Additionally, by offloading data from the ED to a separate device, historical and/or cumulative data may be collected as well. By using historical data, operators can view the results for a particular batch of a product, a specific product, or any number of other useful metrics and make changes to component layouts, module vendors, or any number of other variables. It will also be appreciated that other useful data may be provided with the test result data, such as e.g., data particularly identifying the ED or one or more components thereof, operational parameters at the time the data was collected (e.g., data relating to temperature, accelerometer output, orientation, device housing configuration (e.g., clamshell open/closed), display brightness settings, network interface activity levels, camera on/off, etc, so as to further aid in analysis/diagnosis, as discussed in greater detail below.

### Apparatus—

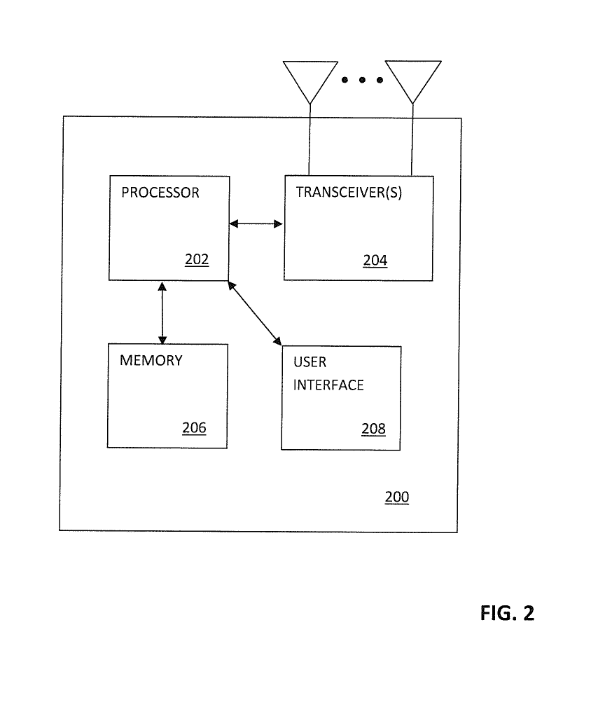

Referring now to FIG. 2, a generalized wireless-enabled electronic device (ED) apparatus 200 useful in conjunction with, e.g., the method of FIG. 1 is illustrated.

In the illustrated embodiment, the apparatus 200 includes a wireless device such as a portable (laptop or handheld) computer (e.g., Macbook™, MacBook Air™, MacBook Pro™, Mac Mini™, iMac™, Mac Pro™, or iPad or iPad mini, each of the foregoing manufactured by the Assignee hereof), mobile communications device (e.g., cellular phone, 3G “UE” or smartphone (e.g., iPhone™ manufactured by the Assignee hereof), PDA, access point (e.g., AirPort™ manufactured by the Assignee hereof), digital media receivers (e.g., AppleTV™ manufactured by the Assignee hereof), etc.). In other embodiments, the apparatus includes a desktop computer, server computer, or so-called “blade” or array computer. Those of ordinary skill in the related arts will readily appreciate that the various principles described herein are applicable to a wide variety of device types, configurations, and/or functions.

As shown in FIG. 2, the ED apparatus 200 includes a processor 202, at least one wireless transceiver subsystem 204, a non-transitory computer-readable medium 206 or other computerized logic, and an external user interface 208.

The processing subsystem 202 includes a central processing unit (CPU) or digital processor 202, such as a microprocessor, digital signal processor, field-programmable gate array, array processor, or plurality of processing components mounted on one or more substrates. The processing subsystem is tightly coupled to operational non-transitory computer-readable medium 206 which may include for example SRAM, FLASH and SDRAM components. The processing subsystem may also include additional co-processors (not shown), such as a dedicated graphics accelerator, network processor (NP), audio processor, or a dedicated application processor. The processing subsystem 202 is configured to execute one or more test scripts and back-end software.

In alternate embodiments (not shown), the ED apparatus 200 may include dedicated logic configured to initialize, execute, and report results for one or more tests from an array of tests. Common examples of such logic include e.g., application specific integrated circuits (ASIC), programmable logic devices (PLDs), field programmable gate arrays (FPGAs), gate array logic (GAL), programmable array logic (PAL), and/or reconfigurable logic fabrics, etc.

The wireless transceiver subsystem 204 includes one or more components which are configured to transmit and receive wireless signals for wireless communication. Wireless transceivers typically include one or more antennas, amplifiers, analog to digital (A/D) converters, digital to analog (D/A) converters, automatic frequency control (AFC), automatic gain control (AGC), baseband processors (BB), etc. Due to the exacting nature of RF transmission, wireless transceiver subsystems can usually be treated in aggregated whole e.g., a whole WLAN subsystem, a whole BT subsystem, a whole cellular subsystem, etc. Moreover, it is appreciated that as wireless technologies have converged and evolved, wireless subsystems have adapted accordingly. For instance, combined WLAN/BT subsystems are commonly used in place of discrete WLAN and BT subsystems.

Exemplary embodiments are further configured to operate as a wireless network server. In one exemplary embodiment, the apparatus 200 complies with IEEE 802.11 wireless local area network (WLAN) standards. Other common wireless technologies include e.g., Bluetooth, wireless USB, Zigbee, and cellular (e.g., 3GPP/LTE/LTE-A, GSM). In certain variants, the apparatus can configure itself to accommodate, ad hoc networking, mesh networking, and/or peer-to-peer networking configurations.

The external user interface system 208 may include any number of well-known I/O devices including, without limitation: a keypad, mouse, touch pad, touch screen (e.g., multi-touch), display, backlights, LEDs, speaker, and microphone, printer, etc. The external user interface 208 is configured to accept one or more user inputs, and provide the one or more user inputs directly or indirectly to the processor 202. The processor is configured to execute one or more test scripts based on at least the user input. The test results are processed, and reported to the user (e.g., via the user interface subsystem).

### Example Apparatus—

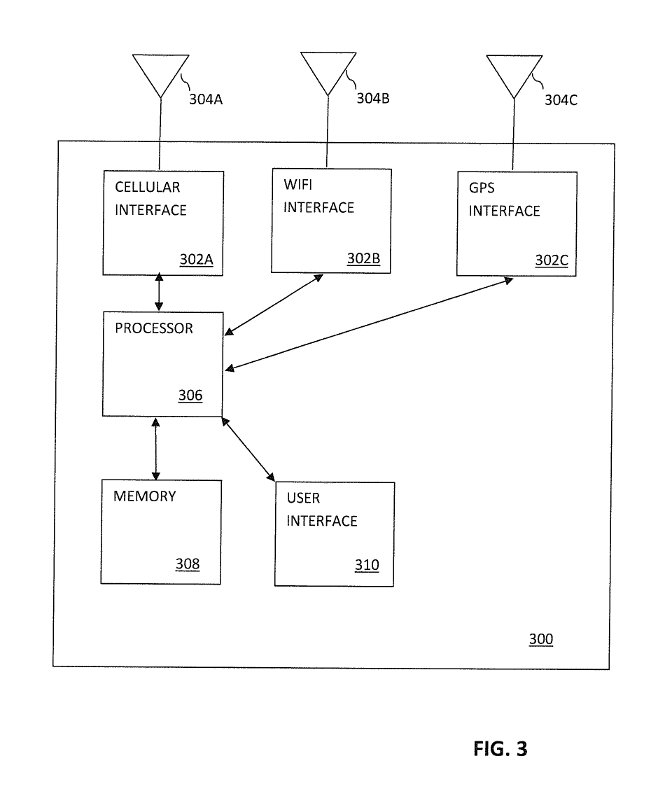

Referring now to FIG. 3, a logical block diagram of one exemplary implementation of a system for internal radio co-existence testing of multiple radios within a wireless-enabled electronic device (ED) 300 is shown. In one embodiment, the ED 300 includes a plurality of radio transceivers or radios: one or more cellular interfaces 302A, a Wi-Fi interface 302B, and a GPS interface 302C (collectively radio transceivers 302) for providing wireless communications. Each of the plurality of radios transceivers 302 is connected to one or more antennas—WCDMA cellular antenna 304A, Wi-Fi antenna 30413, and GPS antenna 304C (collectively radio antennas 304)—for transmitting and receiving signals from the radio transceivers 302, As previously noted, co-existing radio signals often cause varying degrees of interference or dissonance based on physical considerations such as distance, material, structure, etc. In an exemplary implementation, rather than relying on external test equipment to test co-existence performance, the ED 300 internally tests radio operation according to a battery of tests.

In the exemplary implementation, the ED 300 includes an Application Processor (AP) 306 that can be coupled or connected to an external peripheral keyboard or other user interface 310, allowing the AP 306 to act as a computer and perform co-existence testing without using external test equipment. Measurements are made by the AP 306 individually controlling radio transceivers 302. The AP 306 collects In-phase/Quadrature (IQ) data observed one or more of the radio transceivers 302, and, internally to the ED 300, analyzes the data to determine how much dissonance or interference exists. A memory 308 in communication with the AP 306 stores the data observed by the radio transceivers 302, and allows for subsequent post processing of the data.

In addition to controlling the operation of the radio transceivers 302, other parameters can be adjusted, such as the channel or frequency of operation, with the adjustment's impact on co-existing radio transceivers 302 measured for analysis. For example, in one embodiment, the powered cellular radio transceiver 302A is transmitting at a certain frequency and modulation, and a powered-on Wi-Fi radio transceiver 302B is transmitting at a certain power level at a certain frequency.

As a brief aside, an inter-modulation product results from the unintentional mixing of two or more signals that are close together in frequency. For example, when a cellular radio interface 302A transmits at approximately 850 MHz (W-CDMA Band V) and a nearby Wi-Fi interface 302B transmits at 2.4 GHz, a second order inter-modulation product is formed in/near the GPS frequency band (1.6 GHz). The severe dissonance arising from this spectral interference could significantly reduce GPS performance observed at the GPS radio interface 302C. Poor GPS performance results in longer location acquisition times, and less robust location tracking, each of which may be immediately observable to users of the device.

As previously described, typical prior art testing methods required a device to be manually dissembled by testing personnel, and reworked to replace the antenna with external ports for test equipment. During prior art testing, the reworked test ports are used to inject e.g., a Continuous Wave (CW) signal into the cellular antenna and/or a CW GPS signal; the resulting performance is measured against expected results (e.g., simulated results). Those of ordinary skill in the related arts will readily appreciate that the intrusive nature of rework can fundamentally change the RF performance of the device. For example, certain types of measurements e.g., inter-modulation products, may only be present under specific conditions, etc. Since the inter-modulation product is significantly affected by the receiver chain configuration and the antenna system, sometimes it is impossible to reproduce the actual inter-modulation product experienced during normal operation. Moreover, even when an inter-modulation product is identified, the identified inter-modulation product may be a result of the rework process. Accordingly, prior art methods are ill-suited to accurately account diagnose RF problems.

Inter-modulation products are just one example of the many different unforeseeable and unexpected RF effects that could occur with any co-existence configuration. Those of ordinary skill in the related arts will readily appreciate that the nature of RF antenna design is very “finicky”. Prior art testing capabilities which are based on intrusive rework and “canned” test vector generation were generally not representative of the actual device performance. Accordingly, by performing test regimes using the hardware configuration identical (or nearly so) to actual user operational conditions, significant improvement over such prior art approaches is realized by the methods and apparatus of the present disclosure.

Referring back to FIG. 3, when assembled as in the example embodiment, the antennas 304 are arranged inside the actual ED 300 in a “realistic” context, and interference will be picked up by the antennas 304 of the radio 302 being tested, without introducing the additional complications of test apparatus, removal/addition of components, etc.

By connecting an external keyboard (not shown) or other user interface to the AP 306 of the ED 300, the user can initiate a test script. For example, in one scenario, the test script might power on both cellular and Wi-Fi transceivers, and then collect raw IQ (digital in-phase and quadrature) samples measured by the GPS transceiver. The AP 300 then processes the raw IQ samples to determine the amount of dissonance experienced by the GPS radio caused by the actual components and configurations of the ED. As used herein, the term “dissonance” refers generally to deviations from expected performance.

In one exemplary case, an RSSI calculation (or equivalent) can be used. Other more precise reports may provide the frequency and magnitude of one or more detected spikes. Still other reports may include a graphical plot of a frequency range, etc. In an exemplary implementation, a Fast Fourier Transform (FFT) is generated using collected IQ data to determine one or more features of the resulting frequency domain. The FFT provides a magnitude and phase for each discrete frequency component; a so-called “spur” or “spike” represents a large spectral power disturbance that occurs within a relatively small frequency range. Using the example embodiment, the ED 300 is capable of testing any baseband signal(s) that the ED 300 is likely to incur during normal operation.

Moreover, it is appreciated that various principles described herein can be readily applied to other scenarios. For example, a GPS analog-to-digital converter (ADC) (not shown) may be configured (or mis-configured, broken, etc.) in a manner that generates spurs inside the GPS frequency range. Such problems can range from quantization errors to more drastic issues; in some cases, the ADC can saturate the entire GPS frequency band. Such behavior can be easily detected, and diagnosed within the testing framework described herein.

Although the exemplary embodiment has been described with reference to debugging during manufacturing and testing/validation phases, the various principles described herein also advantageously save time and money in terms of obviating rework. Specifically, it is unnecessary to perform the prior art steps of reworking the device (so as to support testing), connecting the reworked device to a suite of specialized equipment, and undoing the rework, etc. The reduction in manual labor and specialized equipment costs can be leveraged across a wide range of potential applications including without limitation: quality assurance, product inspection, research and development, mass production, prototyping, etc.

### Example Operation—

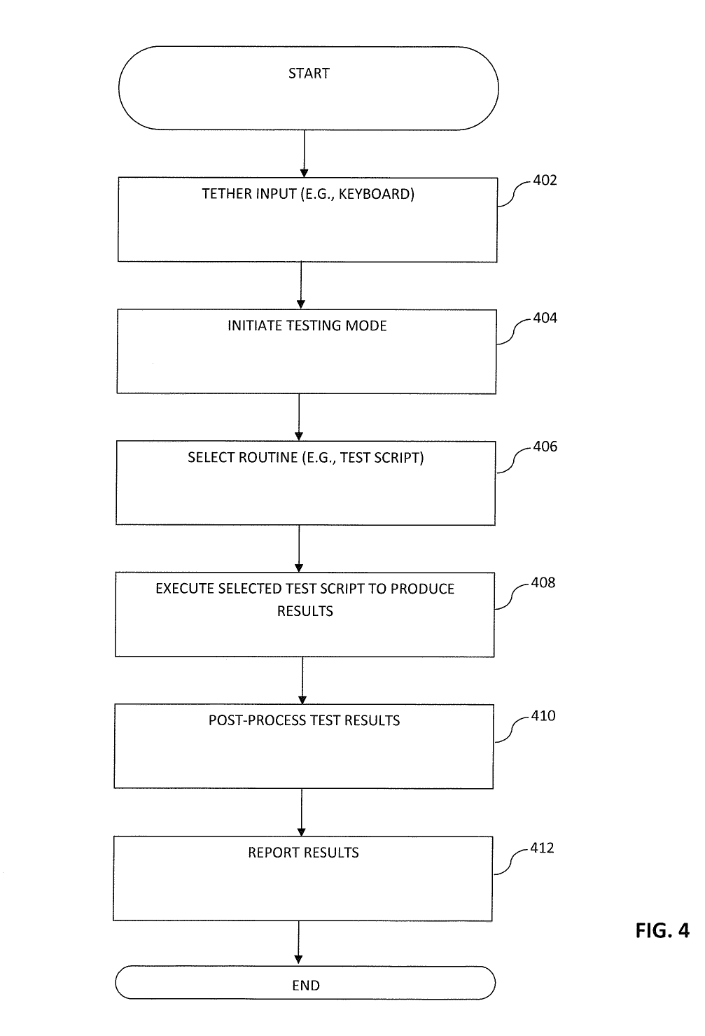

Rescuing now to FIG. 4, one exemplary implementation of a test process 400 for co-existence testing of the ED 300 of FIG. 3 is shown and described.

At step 402 of the method 400, testing personnel connects an external keyboard or other input device to the ED 300. In the exemplary embodiment, the external keyboard or other device is connected to an external port of the ED (e.g., a USB port or similar). In other cases, the external keyboard/device may be wirelessly connected via e.g., a Bluetooth wireless interface. The existing display screen of the ED is used to provide visual information to the testing personnel.

At step 404 of the method 400, the ED initiates a testing mode responsive to the tethering of the external input device. In other cases, the testing personnel may be required to manually initiate the testing mode. In test mode operation, the tester utilizes a simple terminal prompt to enter one or more commands via the tethered input device. Other test interfaces may be more complex, incorporating e.g., touch screen navigation, voice prompts/speech recognition, gesture recognition, etc.

At step 406 of the method 400, the tester selects or indicates one or more test scripts to run. In one such example, the tester may type the file name of a test script at a command prompt. In other cases, the tester may be presented with a menu of potential tests; one or more menu options is/are selected to indicate which test(s) should be run.

Responsive to the tester's selection, the AP 306 of the ED 300 executes the selected script (step 408). For example, in one case, a comprehensive script is selected that tests each permutation of radios 302 of the ED 300, which may also be in a prescribed order (e.g., it may be organized so as to test historically likely problem/failure modes or combinations first, or in a prescribed order, so as to potentially obviate subsequent testing that otherwise might be performed under a “random” or unstructured test regime). Each radio 302 is controlled in this embodiment by the AP 306, and runs through a plurality of test scripts which enable and disable nearby components, in order to assess the performance impact caused by the enabled components.

In one such case, the plurality of test scripts may include for instance: (i) the cellular radio transceiver 302A powered on alone, (ii) the cellular radio transceiver 302A and the Wi-Fi radio transceiver 302B powered on at the same time, (iii) the cellular radio transceiver 302A and the GPS radio transceiver 302C powered on at the same time, and (iv) the cellular radio transceiver 302A, the Wi-Fi radio transceiver 302B, and the GPS radio transceiver 302C powered on at the same time. For each of these test cases, the raw data samples of the cellular radio transceiver 302A are collected. In some cases, the tests may be further configured to test certain modes of operation e.g., channels, frequencies, modulation and coding schemes (MCS), frequency hopping, etc.

While the foregoing example is provided in terms of the cellular radio transceiver 302A, analogous procedures can be performed for each of the other radios. Moreover, it is appreciated that all components generate, to some degree, electromagnetic interference (EMI) and may interfere with intended operation to varying degrees (e.g., excessive power consumption, etc.). Thus, while the foregoing example is presented with respect to various radio components, it is appreciated that those of ordinary skill in the related arts may readily adapt the foregoing process to other components, given the contents of the present disclosure. For example, one or more components such as a camera (not shown) within the ED 300 or the display of the ED 300 can emit certain EMI signatures which may be problematic. Since the testing is performed within the finally assembled device form factor, using actual signals, elements such as the camera and display can be taken into account, whereas this is not available or is not practical with prior art methods.

Another advantage of the exemplary techniques described herein over other prior art methods is that multiple antennas may be independently tested. For example, the transmitter path may be changed (such as in the case of a MIMO antenna array, or separate lower and upper band antennas), and the interaction monitored. Previously, cellular transmission could not be turned off at the control level; in order to test EDs, an operator would turn off the cellular receiver and merely listen. In contrast, under the exemplary paradigms described herein, the cellular transmit is controlled to transmit on one antenna (e.g., the lower band antenna), or transmit on the other (e.g., upper band) antenna, allowing for independent testing of the antennas.

At step 410, the collected data samples are post-processed and/or provided to a database for subsequent analysis (step 412). In one such case, the post processing includes calculation of RSSI from the collected samples for each of the test cases. In other examples, the post processing may include spectral analysis (e.g., a display of the spectral components, etc.) and/or other forms of quantitative analysis (e.g., BER, SNR, etc.).

In various disclosed embodiments, data is downloaded off of the ED and post processing is performed remotely. In other embodiments, the processing occurs on the actual device. Various combinations of the foregoing may be used as well; for example, where the ED performs some of the less computationally intensive tasks onboard, while the external device(s) are tasked with performance of the remaining operations. Alternatively, the ED may pre-process data on board (such as filtration, error correction, etc.), and forward the pre-processed data to one or more external entities.

As previously noted, in addition to factory testing of completed products, methods and apparatus disclosed herein can also be used for, inter alia, debugging during the design phase, such as to measure the effects of using different internal parts and/or the configuration of the parts. Hence, a designer can readily and accurately test the effects of different design configurations via a prototype, before the design is finalized and put into mass production. Obviously, the more the prototype resembles the final production device, the better the accuracy of the results (e.g., use of test fixtures for components, failure to have the entire device housing in place, and/or use of different housing or other component materials, may all detract from the accuracy of the results).

Individual EDs may vary in performance from one another due to e.g., component tolerances, multi-sourced components from different vendors, etc. Still further, performance will significantly change as ED designs evolve with customer demands, new technologies, etc. Accordingly, a database of ED performance can provide important statistical data which is necessary to further improve various designs, etc. Statistical data can be used to, among other things, identify outliers, identify problematic devices, identify adverse component interactions, inform future designs, experimentally determine operating tolerances, etc. In some cases, the statistical data may additionally be associated with meta-data regarding the device's construction, components, etc.

It should be noted that statistical data was difficult to obtain and/or not collected for prior art manufacturing approaches of the type previously described herein. Prior art methods were heavily dependent upon manual testing, and human error could be easily introduced into collected data. Since the time and cost required setting up and running the tests were prohibitive, most testing was done on smaller sample basis (i.e., in some cases, not every individual production device was tested, but rather a statistically significant sample). The simplification and automation described herein both improves the accuracy of data, and enables large scale statistical analysis of manufactured devices, including commercially practical testing of every device manufactured if desired.

Lastly, at step 412, the completion of testing is reported to the testing personnel or other entity. In some cases, the report may be a simple beep and/or LED (green for pass, red for fail). In other cases, the report may be more complex, and incorporate various audio and visual feedback (e.g., graphical plots, verbose logging, etc.). The report may also be compiled by e.g., a server or logical process (e.g., application), which then provides aggregated data results for multiple devices to a human or other supervisory process or entity.

It will be recognized that while certain embodiments are described in terms of a specific sequence of steps of a method, these descriptions are only illustrative of the broader methods of the present disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the principles disclosed and claimed herein.

While the above detailed description has shown, described, and pointed out novel features of the various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles. The scope of the present disclosure should be determined with reference to the claims.

What is claimed is:

1. A method for testing a wireless device having a plurality of wireless transceivers, the method comprising:
providing a user interface comprising at least a display and an input device;
responsive to a user selecting a test script associated with at least one radio interface, executing the selected test script;
collecting data associated with the executed test script via the at least one radio interface; and
processing the collected data.

2. The method of claim 1, further comprising reporting one or more results via the user interface.

3. The method of claim 1, where the display and the input device are indigenous to the wireless device.

4. The method of claim 1, where at least one of the display and the input device is connected to the wireless device via an external data port of the wireless device.

5. The method of claim 1, where the test script is configured to determine a received signal strength.

6. The method of claim 5, where the determined received signal strength is utilized as a baseline performance metric.

7. The method of claim 6, where the test script is configured to determine a second received signal strength while at least one other radio interface is enabled, and where post-processing comprises determining the difference between the second received signal strength and the baseline performance metric.

8. The method of claim 1, where post-processing the collected data comprises calculating a Fast Fourier Transform (FFT) of the collected data.

9. The method of claim 8, where reporting the one or more results comprises displaying a graphical plot of the FFT.

10. A wireless device configured to perform one or more tests, the wireless device comprising:
a plurality of wireless transceivers configured to transmit and receive wireless signals according to one or more radio technologies;
a processor; and
a non-transitory computer readable medium comprising one or more instructions that are configured to, when executed by the processor, cause the wireless device to:
responsive to starting an automated test mode, execute one or more test scripts, the one or more test scripts associated with at least a first transceiver of the plurality of wireless transceivers;
collect test data associated with the via the first transceiver; and
transmit the test data to an external entity.

11. The wireless device of claim 10, where the test data comprises one or more In-phase and Quadrature (IQ) data samples received via the first transceiver.

12. The wireless device of claim 10, further comprising one or more instructions configured to, when executed, enable the first transceiver, and disable all other transceivers.

13. The wireless device of claim 10, further comprising one or more instructions configured to, when executed, enable the first transceiver, and enable at least one other transceiver.

14. The wireless device of claim 10, further comprising one or more instructions configured to, when executed, post-process the collected test data with the processor of the wireless device.

15. The wireless device of claim 14, where the external entity is configured to generate statistical data from test data collected from a plurality of wireless devices.

16. A method for testing a plurality of wireless devices, the method comprising:
for each wireless device of the plurality of wireless devices:
initiating a test procedure, the test procedure causing the each wireless device to execute one or more test scripts, where each test script is associated with a transceiver selected from a plurality of transceivers of the wireless device;
collecting test data corresponding to each wireless device; and
post-processing the collected data the post-processing comprising statistical analysis.

17. The method of claim 16, where the executed one or more test scripts are configured to test at least one co-existence scenario.

18. The method of claim 16, where the executed one or more test scripts are configured to test at least one baseline scenario.

19. The method of claim 16, where the statistical analysis comprises determining an operational tolerance.

20. The method of claim 16, where the statistical analysis comprises identifying adverse component interactions.

21. A wireless device configured to perform one or more tests, the wireless device comprising:
a wireless transceiver configured to transmit and receive wireless signals according to one or more radio technologies;
one or more components of interest;
a processor; and
a non-transitory computer readable medium comprising one or more instructions that are configured to, when executed by the processor, cause the wireless device to:
execute one or more test scripts, the one or more test scripts associated with at least the wireless transceiver and one or more of the one or more components of interest;
collect test data relating to the first transceiver; and
utilize the collected data to identify one or more problematic interactions between the one or more components of interest and the transceiver.
